(19) United States
(12) Patent Application Publication
(10) Pub. No.: US 2025/0084538 A1
(43) Pub. Date: Mar. 13, 2025

(54) METHOD FOR ALKALINE CLEANING OF ZINC-MAGNESIUM-ALLOYED STRIP STEEL

(71) Applicant: Henkel AG & Co. KGaA, Duesseldorf (DE)

(72) Inventors: Michael Wolpers, Erkrath (DE); Sarah Klaes, Duesseldorf (DE)

(21) Appl. No.: 18/956,151

(22) Filed: Nov. 22, 2024

Related U.S. Application Data
(63) Continuation of application No. PCT/EP2023/063633, filed on May 22, 2023.

(30) Foreign Application Priority Data
May 25, 2022 (EP) 22175373.4

(51) Int. Cl. C23G 1/14

(52) U.S. Cl. CPC C23G 1/14

(57) ABSTRACT

The present invention relates to a method for the wet-chemical cleaning and conditioning of hot-dip galvanized (ZM) steel by contacting it with an alkaline aqueous composition containing magnesium ions dissolved in water, and at least one complexing agent. Also provided is a method for pre-treating strip steel by hot-dip galvanization (ZM) on one or both sides in order to protect the steel against corrosion, in which a cleaning according to the invention is followed by a wet-chemical conversion coating and a subsequent building of a varnish layer. The present invention also relates to an alkaline aqueous composition containing both magnesium ions and iron ions, which is particularly suitable for the cleaning and subsequent surface treatment for protection against corrosion, as well as to a system of complexing agents.

The present invention relates to a method for the wet-chemical cleaning and conditioning of hot-dip galvanized (ZM) steel by contacting it with an alkaline aqueous composition containing magnesium ions dissolved in water, and at least one complexing agent. A method for pre-treating strip steel by hot-dip galvanization (ZM) on one or both sides in order to protect the steel against corrosion is also included, in which a cleaning according to the invention is followed by a wet-chemical conversion coating and a subsequent building of a varnish layer. The present invention also relates to an alkaline aqueous composition containing both magnesium ions and iron ions, which is particularly suitable for the cleaning and subsequent surface treatment for protection against corrosion, as well as to a system of complexing agents.

In automotive manufacturing, the use of zinc coatings on steel alloyed with magnesium is gaining importance due to the increasing demand for bodies in lightweight construction. Compared to other hot-dip galvanizations, a coating of zinc and magnesium provides a significantly increased anti-corrosion effect and, in particular, excellent resistance to corrosive delamination even after painting with organic topcoats and dip paint. Due to this improved property profile, coatings in a smaller layer thickness can be provided, which nevertheless meet the high demands on recoatability and corrosion protection. The weight savings associated with the smaller layer thickness make it possible to use hot-dip galvanized (ZM) steel as a resource-saving strip material for the manufacture of lightweight car bodies, so that, in automotive manufacturing, the surface area of this material on the car bodies is further increased alongside to the surface area of other lightweight metals such as aluminum.

The metallic coating applied to hot-dip galvanized (ZM) steel strip contains approximately 1.5 to 8 wt. % of the metals aluminum and magnesium, the proportion of magnesium being at least 0.2 wt. %. The basic suitability of these coatings in conventional methods established in the prior art for being shaped, pretreated and coated are recognized and demonstrated in principle (Characteristic Properties 095 E, “Continuously Hot-Dip Coated Steel Strip and Sheet”, Chapters 8 and 10, 2017 edition, Wirtschaftsvereinigung Stahl), but on the basis of the particular composition of the coating and the native oxide layer, there are special features which have to be taken into account, in particular in the case of cleaning and pretreatment, for a coating result which is as homogeneous and reproducible as possible and thus optimal anti-corrosion characteristics or the desired surface functionality.

It is known from the prior art, for example, that in the course of cleaning, prior to a corrosion-protecting pre-treatment of hot-dip galvanized (ZM) strip steel, a change in the proportion of oxides of the alloy component magnesium may be necessary for sufficient adhesion to a subsequently applied varnish layer. For example, US 2016/0010216 A1 reports that the extensive removal of magnesium oxide in the oxide layer close to the surface of hot-dip galvanized (ZM) strip steel can effectively suppress the occurrence of bubble-like protrusions in the topcoat, known as “blistering”. For this purpose, US 2016/0010216 A1 proposes a treatment of the strip steel with a neutral or alkaline aqueous composition containing a strong complexing agent for magnesium, either in conjunction with or after the degreasing process. The proposed complexing agents are selected from organic acids or their salts and preferably selected from glycine and diphosphoric acid. At the same time, a pH value in the region of 7-11.5, in particular 9-10, is recommended for sufficient removal of the oxidic magnesium species from the substrate surface and thus a mildly alkaline cleaning stage.

In contrast to this prior art, the present invention has the object of making the strongly alkaline cleaners established in strip pre-treatment lines usable for the treatment of hot-dip galvanized (ZM) strip steel without having to accept disadvantages in terms of varnish adhesion and in particular with regard to blistering. Strongly alkaline cleaners have the technical advantage that the degreasing and cleaning of the strip steel can be carried out in just one treatment stage. In contrast, in the case of mild alkaline conditioning, i.e. changing the surface quality, of the hot-dip galvanized (ZM) surfaces, depending on the degree of soiling of the coil, a strongly alkaline degreasing stage procedurally must be carried out prior to the conditioning in order to achieve the desired surface quality while at the same time ensuring good varnish adhesion. A further advantage of using strongly alkaline cleaning and degreasing baths is that, due to the high pickling rate for aluminum, which is an alloy component and metallic phase of hot-dip galvanizing, the coil coating line can also be easily fed with other hot-dip galvanized strip steel grades, e.g. (Z), which saves resources in the pre-treatment and minimizes lead times and changeover costs for coil coating of different hot-dip galvanized steel grades. The object profile of the present invention also includes the necessary compatibility of the cleaning with amorphous inorganic conversion layers applied in the pre-treatment line, which once again significantly increase the adhesion of primer coatings and thus also the resistance of topcoats to corrosive delamination and blistering.

It has now been shown that excellent protection against blistering is possible after a corrosion-protecting pre-treatment based on a strongly alkaline cleaning stage upstream of the conversion coating if a minimum quantity of magnesium ions and at least one complexing agent are present in the cleaning stage. Under these conditions, there is no preferential pickling of magnesium on the (ZM) substrate surface and the alkaline pickling additionally enriches magnesium from the aqueous phase on the hot-dip galvanized surface. This active enrichment of magnesium on the (ZM) surface is now surprisingly responsible for improved corrosion protection and varnish adhesion after cleaning pre-treatment in a strongly alkaline medium.

The present invention therefore relates, in a first aspect, to a method for cleaning and conditioning of hot-dip galvanized (ZM) steel by contacting it with an alkaline aqueous composition containing at least 1.0 mmol/kg of magnesium ions dissolved in the aqueous phase and at least one water-soluble organic complexing agent, the free alkalinity of the composition being greater than 3.0 in points and the pH being greater than 11.5.

In the context of the present invention, a hot-dip galvanization (ZM) is a metallic coating on steel containing 1.5 to 8 wt. % of the metals aluminum and magnesium, the proportion of magnesium in the metallic coating preferably being at least 0.2 wt. %.

The free alkalinity or total alkalinity is determined by titrating 2 grams of the aqueous composition, diluted to 50 ml, with 0.1 n hydrochloric acid to a pH value of 8.5 or 3.6. The consumption of acid solution in ml indicates the score of free alkalinity or total alkalinity.

The pH value is defined as the negative decadic logarithm of the hydronium ion activity and can be determined directly in a sample volume of the composition using pH-sensitive glass electrodes after calibration with standard buffer solutions.

For a sufficiently high pickling rate and degreasing effect, which is particularly important for homogeneous surface conditioning and cleaning results in the pre-treatment of flat strip products due to the very short throughput times through corresponding baths or spray zones, it is advantageous according to the invention if the total alkalinity in points is greater than 5.0, especially preferably greater than 10.0, particularly preferably greater than 12.0. For the same reason, it is advantageous if the free alkalinity of the composition in points is set to be greater than 6.0, especially preferably greater than 8.0. The ratio of total alkalinity to free alkalinity each in points is preferably less than 3.0, especially preferably less than 2.5, in particular less than 2.2, in order to ensure sufficient pickling in continuous operation of a pre-treatment line and is therefore an important process control variable.

The preferred pH value of the composition in the method according to the invention is above 12.0, preferably above 12.5, so that a surface coating based on oxides/hydroxides of magnesium is maintained, while oxides/hydroxides and metallic aluminum of the hot-dip galvanization are actively dissolve. In this way, enrichment of magnesium on the hot-dip galvanized steel surface and thus improved varnish adhesion after primer and topcoat coating is promoted. Preferably, the pH value of the composition is set according to the invention such that it is less than 13.5, especially preferably less than 13.0, in order to avoid overpickling and the associated excessive removal of material on the one hand and an excessive introduction of zinc ions into the pre-treatment stages on the other.

Furthermore, sufficient protection against blistering of organic top layers applied to hot-dip galvanized (ZM) steel requires the presence of magnesium ions dissolved in the aqueous phase of the strongly alkaline composition of the method according to the invention. In this respect, it is found that, based on the composition, at least 1.0 mmol/kg of magnesium is required, preferably at least 2.0 mmol/kg, especially preferably at least 3.0 mmol/kg, particularly preferably at least 4.0 mmol/kg, in order to effectively suppress blistering after topcoat coating. It is found that in the presence of magnesium ions, an additional layer thickness of magnesium forms on the hot-dip galvanized steel surfaces, which proves to be advantageous for varnish adhesion in the material (ZM). Higher contents are not sufficiently stabilized in the strongly alkaline medium even in the presence of the complexing agent or require correspondingly high proportions of complexing agent, but do not significantly improve the adhesion of subsequently applied primers and topcoats, such that according to the invention it is preferred that, in each case based on the strongly alkaline aqueous composition, not more than 0.080 mol/kg, especially preferably not more than 0.020 mol/kg, of magnesium ions dissolved in the aqueous phase are contained.

Any water-soluble magnesium salts can be used as a source of magnesium ions, but nitrates, sulfates, carbonates and/or salts of α-hydroxycarboxylic acids, for example glycolic acid, lactic acid, tartaric acid, malic acid, aldaric acids, aldonic acids and/or glucoheptonic acid, are particularly suitable and therefore preferred.

The additional layer thickness on the hot-dip galvanized (ZM) surface in the range of a few milligrams of magnesium per square meter achieved in the method according to the invention is supported by the presence of the complexing agent and can be further increased by selecting certain complexing agents, which is then accompanied by a further optimization of the adhesion of organic top layers applied to the (ZM) substrate.

A complexing agent within the meaning of the present invention is a Lewis base and organic compound having a molar mass of not more than 500 g/mol and comprising at least two functional groups having heteroatoms with at least one free electron pair. In a preferred embodiment of the method according to the invention, the at least two functional groups of the complexing agent contained in the alkaline aqueous composition are selected from carboxylic acid, phosphonic acid, phosphoric acid, amino and/or hydroxyl groups, with the proviso that complexing agents containing at least one amino or hydroxyl group also have at least one functional group selected from a carboxylic acid, phosphonic acid or phosphoric acid group. In this preferred embodiment, the complexing agent is therefore always an acid and, in the context of the present invention, can also be partially or completely contained in the form of the corresponding salt in the alkaline aqueous composition or added thereto.

It is generally advantageous for the formation of a layer thickness of magnesium if the complexing agent is only weakly complexing. In the method according to the invention, the complexing agents of the alkaline aqueous composition are therefore selected from those having a complex formation constant pK_{L} for magnesium below 2.0, preferably below 1.5, especially preferably below 1.0.

The term “complex formation constant pK_{L}” is defined in the scope of the application as the decadic logarithm of the equilibrium constant K_{L} of the complex formation reaction at 25° C. in water, where the equilibrium constant K_{L} of the complex formation reaction is given by: K_{L}=[MgLₙ]/[Mg][L]ₙ where [MgLₙ] is the molar equilibrium concentration of the magnesium complex, [Mg] is the molar equilibrium concentration of the metal ion, [L] is the molar equilibrium concentration of the ligand, and n is the number of ligands bound in the complex for which the highest complex formation constant pK_{L} results for the respective ligand.

Suitable weak complexing agents with a pK_{L} value below 2.0 are preferably α-hydroxycarboxylic acids, which in turn are preferably selected from the group consisting of glycolic acid, lactic acid, tartaric acid, malic acid, aldaric acids, aldonic acids and/or glucoheptonic acid, wherein especially preferably at least one aldonic acid, in particular gluconic acid and/or glucoheptonic acid, and very especially preferably gluconic acid is selected.

If weak complexing agents are combined with stronger complexing agents in the alkaline aqueous composition in the method according to the invention, the coating of the hot-dip galvanized steel surfaces with magnesium can be surprisingly reinforced and the adhesion to the primer and topcoat can thus be further improved on (ZM).

In preferred embodiments, in addition to the at least one weak complexing agent for magnesium mentioned above, therefore at least one further complexing agent is contained, which is selected either
a) from di- and/or triphosphonic acids, preferably from etidronic acid (HEDP) and/or aminotrimethylene phosphonic acid (ATMP), especially preferably from aminotrimethylene phosphonic acid, or
b) from organic compounds having at least three carboxyl groups and at least one secondary and/or tertiary amino group, especially preferably from β-alaninediacetic acid, N-(1-carboxyethyl)iminodiacetic acid, diethylenetriaminepentaacetic acid, ethylenediaminetetraacetic acid, nitrilotriacetic acid and/or iminodisuccinic acid, particularly preferably from iminodisuccinic acid.

Particularly preferred with regard to the quantitative ratios and proportion of complexing agents in the alkaline aqueous composition is a method according to the invention in which the proportion of complexing agents in the composition is at least 2.0 mmol/kg, especially preferably at least 4.0 mmol/kg, particularly preferably at least 5.0 mmol/kg, but the total proportion of complexing agents, in each case based on the composition, is preferably not greater than 50 mmol/kg, especially preferably not greater than 40 mmol/kg, particularly preferably not greater than 30 mmol/kg. It is further preferred if the proportion of complexing agents having a complex formation constant pK_{L} for magnesium below 2.0, in particular aldonic acids and/or glucoheptonic acid, based on the total proportion of complexing agents, is preferably at least 60 mol %, especially preferably at least 80 mol %, and particularly preferably at least one further complexing agent selected from one of the groups a) or b) mentioned in the previous paragraph is contained, again preferably at least 10 mol % of complexing agents of the groups a) and b) mentioned in the previous paragraph based on the total proportion of complexing agents. For a positive effect on the magnesium deposition due to the additionally introduced complexing agents according to groups a) and/or b) mentioned in the previous paragraph, a total amount of these complexing agents of at least 0.2 mmol/kg, especially preferably at least 0.4 mmol/kg is preferred, but their total amount should preferably not exceed 2.0 mmol/kg, especially preferably 1.5 mmol/kg, very especially preferably 1.0 mmol/kg, since otherwise the advantageous increase in the magnesium coating can no longer be realized on a regular basis and, in addition, a deterioration can occur compared to such compositions which contain only weak complexing agents (pK_{L} below 2.0).

Such a preferred system of complexing agents in the alkaline aqueous composition is particularly suitable for a sufficient and homogeneous surface coating of the hot-dip galvanized steel with magnesium. (ZM) substrates conditioned according to the method of the invention, which are pre-treated to protect against corrosion and coated with a primer and topcoat, show excellent adhesion after forming and no blistering occurs even after weeks of exposure to condensing moisture.

The manner of contacting the alkaline aqueous composition can be freely selected in the method according to the invention. However, dipping and spraying methods are preferred.

In a second aspect, the present invention therefore also relates to a method for a cleaning and corrosion-protecting surface treatment of strip steel having a hot-dip galvanization (ZM) on either one or both sides, in which the hot-dip galvanized (ZM) surface of the strip steel
i) optionally, is first degreased;
ii) is treated according to a method for conditioning and cleaning as described above;
iii) subsequently undergoes a conversion coating by contacting with an acidic aqueous composition containing water-soluble compounds of the elements Zr, Ti and/or Si, the aqueous agent preferably having a pH value in the range from 1.0 to 5.0, and wherein the contacting is preferably carried out by applying a wet film of the composition, in particular by spraying/squeezing or rolling on, and the wet film is then dried in place; and
iv) is subsequently provided either with a topcoat with or without a previous primer coating or with a dip paint, in particular an electrophoretic dip paint.

The process steps i)-iv) are consecutive, but can be interrupted by intermediate steps, which can constitute regular rinsing steps, wherein rinsing steps are intended to remove active components from an immediately preceding wet-chemical treatment step, which adhere to the strip steel as a wet film and cannot be dried in place, from the surface of the component as far as possible by means of a rinsing solution.

The conversion coating in method step iii) is carried out using acidic aqueous compositions which produce an amorphous oxide/hydroxide coating based on the elements Zr, Ti and/or Si and accordingly contain compounds of the elements Zr, Ti and/or Si dissolved in water. The term “dissolved in water” comprises molecularly dissolved species and compounds that dissociate in aqueous solution and form hydrated ions.

As water-soluble compounds of the elements Zr, Ti or Si, their fluoric acids are particularly suitable. Typical representatives of water-soluble compounds are hexafluorotitanic acid (H₂TiF₆), hexafluorozirconic acid (H₂ZrF₆) and hexafluorosilicic acid (H₂SiF₆) and their salts, but also titanyl sulfate (TiO(SO₄)), titanyl nitrate (TiO(NO₃)₂) and ammonium zirconium carbonate ((NH₄)₂ZrO(CO₃)₂).

Organosilanes are also suitable as water-soluble compounds of the element Si, which, however, are preferably contained in addition to one or more compounds of the elements Zr and/or Ti. Such organosilanes preferably have at least one hydrolyzable aliphatic radical, which is preferably selected from alkoxy groups having preferably no more than 2 carbon atoms and especially preferably at least one non-hydrolyzable aliphatic radical, which is preferably selected from alkyl groups having preferably no more than 6 carbon atoms, which especially preferably additionally have at least one primary amine, glycidyl or hydroxyl group. Typical representatives of these organosilanes are (3-glycidyloxypropyl)trimethoxysilane and 3-aminopropyltriethoxysilane.

A conversion coating based on the fluoric acids of the element Ti is particularly preferred in the method according to the invention according to the second aspect of the present invention, since such layers form optimally when formed by drying in place (“dry-in-place” method) and have a high compatibility in the acidic aqueous medium for the additivation with polymeric components, as described in DE 102006039633 A1, and therefore impart particularly good varnish adhesion, such that, depending on the requirement profile, a primer coating in step vi) can be dispensed with.

Usually, the layer thicknesses of Zr, Ti and/or Si, in particular Zr and/or Ti, in methods for a cleaning and corrosion-protecting surface treatment of strip steel, must be set within a very narrow range, as otherwise either the layer thickness is too low for an inorganic primer coating that protects against corrosion, or, above a tolerable threshold value, a significant deterioration in the adhesion to the primer and topcoat is already caused. However, an advantage of the method according to the invention is that a wider application window is made accessible for the conversion coating, since the performance with regard to varnish adhesion only drops significantly at layer thicknesses above 20 mg/m² based on the elements Zr, Ti and/or Si. Accordingly, it is preferred that the contacting in method step ii) is carried out for such a duration or in such an application quantity that on the hot-dip galvanized (ZM) surfaces of the strip steel, after drying step iv), results a layer thickness of Zr, Ti and/or Si of at least 1 mg/m² in each case, especially preferably of at least 2 mg/m² in each case based on the respective element, but preferably not more than 20 mg/m² in total, especially preferably not more than 12 mg/m² in total based on the elements Zr, Ti and/or Si.

In a final aspect, the present invention also relates to an alkaline aqueous composition for cleaning and conditioning hot-dip galvanized (ZM) steel, which is particularly suitable in the context of the methods according to the invention described above and which establishes a system of complexing agents optimized for the formation of a homogeneous layer thickness of magnesium.

This alkaline aqueous composition according to the invention has a free alkalinity in points of greater than 3.0 and a pH value of greater than 11.0 and contains
a) at least 1.0 mmol/kg of magnesium ions dissolved in water, and
c) a system of complexing agents consisting of more than 2.0 mmol/kg, preferably more than
   5.0 mmol/kg, but less than 50.0 mmol/kg, preferably less than 30.0 mmol/kg, of complexing agents having a complex formation constant pK_{L} for magnesium of less than 2.0, preferably selected from glycolic acid, lactic acid, tartaric acid, malic acid, aldaric acids, aldonic acids and/or glucoheptonic acid, especially preferably from aldonic acids and/or glucoheptonic acid, particularly preferably from gluconic acid, and
c1) more than 1.0 mmol/kg, but less than 10.0 mmol/kg of at least one di- and/or triphosphonic acid, preferably etidronic acid and/or aminotrimethylene phosphonic acid, especially preferably aminotrimethylene phosphonic acid, and/or
c2) more than 1.0 mmol/kg, but less than 10.0 mmol/kg of at least one organic compound having at least three carboxyl groups and at least one secondary and/or tertiary amino group, preferably β-alaninediacetic acid (β-ADA), N-(1-carboxyethyl)iminodiacetic acid, diethylenetriaminepentaacetic acid, ethylenediaminetetraacetic acid, nitrilotriacetic acid, iminodisuccinic acid, especially preferably iminodisuccinic acid.

As preferred embodiments of the composition according to the invention, all those variants of the alkaline aqueous composition for cleaning and conditioning mentioned in the context of the first aspect of the present invention are considered equally preferred, insofar as they do not explicitly relate to the system of complexing agents.

The composition according to the invention, as well as the methods according to the invention, can also be used for conditioning and cleaning all other hot-dip galvanized steel grades, in particular hot-dip galvanized (Z), alloy galvanized, especially (ZF), (ZA), or aluminum-coated (AZ), (AS) steel. This opens up the possibility of operating the pre-treatment stages of a coil coating plant with precisely these hot-dip galvanized steel grades without having to “retool” the respective stages, in particular the cleaning and degreasing stage, wet-chemically when changing the strip steel grade, e.g. from (ZM) to (Z) and vice versa.

All objects and aspects relating to the present invention, be it the method for conditioning and cleaning or the method for cleaning and corrosion-protecting surface treatment or the alkaline aqueous composition for conditioning and cleaning itself, have in common that the respective alkaline aqueous composition can be additivated, but certain additives mentioned below can have a negative effect on the performance of the conditioning and should therefore preferably not be contained or only be contained in small amounts.

These include some electropositive metal ions which, when present in the alkaline environment of the cleaning and conditioning, can be deposited in metallic form on the hot-dip galvanized steel and thereby disrupt or even prevent the formation of a layer thickness of magnesium required for improved varnish adhesion.

Accordingly, it is preferred for all objects of the present invention that the proportion of water-soluble compounds of the elements Ni or Co, preferably the proportion of water-soluble compounds of metal elements which have a more positive standard reduction potential than iron, in the composition is in each case less than 10 mg/kg, preferably less than 5 mg/kg, especially preferably less than 1 mg/kg, in each case as a proportion of the element and based on the composition.

Furthermore, the presence of phosphates can also have a detrimental effect on the performance of the conditioning, i.e. the desired surface coating with magnesium, such that their total proportion comprising orthophosphate and metaphosphates such as pyrophosphate in the alkaline aqueous composition and in the context of all objects of the present invention is preferably less than 0.100 g/kg, especially preferably less than 0.050 g/kg, particularly preferably less than 0.010 g/kg and very especially preferably less than 0.005 g/kg calculated as PO4 and based on the composition.

The same applies to the presence of water-dispersed or water-dissolved polymeric organic compounds having a molar mass above 500 g/mol, which are not surfactants, preferably not non-ionic surfactants, so that their total proportion in the alkaline aqueous composition and in the context of all objects of the present invention is preferably less than 0.100 g/kg, especially preferably less than 0.050 g/kg, particularly preferably less than 0.010 g/kg and very especially preferably less than 0.005 g/kg based on the composition.

However, the presence of iron ions can improve the formation of the conversion coating in method step iii) of the method according to the second aspect of the present invention on the hot-dip galvanized surfaces, and can have a positive effect on conditioning and varnish adhesion. In this respect, in the context of all objects of the present invention, the alkaline aqueous composition preferably additionally contains iron ions dissolved in water, preferably at least 0.4 mmol/kg, especially preferably at least 1.0 mmol/kg, very especially preferably at least 1.5 mmol/kg of iron ions, but preferably less than 0.040 mol/kg, very especially preferably less than 0.010 mol/kg of iron ions, in each case based on the composition. A suitable source of iron ions dissolved in water are again the nitrates, sulfates, carbonates and/or salts of α-hydroxycarboxylic acids, for example glycolic acid, lactic acid, tartaric acid, malic acid, aldaric acids, aldonic acids and/or glucoheptonic acid.

However, in the context of all objects of the present invention, suitable additives to the alkaline, aqueous composition for cleaning and conditioning are surfactants. In preferred embodiments, the alkaline aqueous composition additionally contains at least one surfactant, which is preferably selected from nonionic surfactants, preferably having an HLB value of at least 8, especially preferably of at least 10, particularly preferably of at least 12, but preferably of not more than 18, especially preferably of not more than 16, wherein the total proportion of the surfactants, preferably of the non-ionic surfactants, is preferably greater than 0.050 g/kg, especially preferably greater than 0.100 g/kg, particularly preferably greater than 0.200 g/kg, but the total proportion of the surfactants is preferably not greater than 5.0 g/kg, especially preferably not greater than 2.0 g/kg, in each case based on the composition. The HLB value (hydrophilic-lipophilic balance) is calculated as follows according to Formula I and can assume values of zero to 20 on an arbitrary scale:

$$HLB = 20 \cdot ( 1 - {M}_{1} / M ) \qquad ( I )$$

where M₁: molar mass of the lipophilic group of the non-ionic surfactant
M: molar mass of the non-ionic surfactant

In terms of substance, such non-ionic surfactants are preferred which are selected from alkoxylated alkyl alcohols, alkoxylated fatty amines and/or alkyl polyglycosides, especially preferably from alkoxylated alkyl alcohols and/or alkoxylated fatty amines, particularly preferably from alkoxylated alkyl alcohols. In this case, for a defoaming effect, the alkoxylated alkyl alcohols and/or alkoxylated fatty amines are preferably end-capped, particularly preferably having an alkyl group which in turn preferably has no more than 8 carbon atoms, particularly preferably no more than 4 carbon atoms. Especially preferably, such alkoxylated alkyl alcohols and/or alkoxylated fatty amines are additivated as non-ionic surfactants which are present in ethoxylated and/or propoxylated form, the number of alkylene oxide units preferably being in total no greater than 16, especially preferably no greater than 12, particularly preferably no greater than 10, but especially preferably greater than 4, particularly preferably greater than 6.

With regard to the lipophilic component of the non-ionic surfactants mentioned above, alkoxylated alkyl alcohols and/or alkoxylated fatty amines whose alkyl group is saturated and preferably unbranched are preferred as non-ionic surfactants for the additivation, the number of carbon atoms in the alkyl group preferably being greater than 6, especially preferably at least 10, particularly preferably at least 12, but preferably no greater than 20, especially preferably no greater than 18, particularly preferably no greater than 16.

### EXAMPLES

To illustrate the effect of compositions according to the invention in methods according to the invention for suppressing so-called blistering, hot-dip galvanized (ZM) sheet metal sections (ZM120 MC, d=0.58 mm) were first cleaned and conditioned and then pre-treated to protect against corrosion and provided with a polyurethane-based primer and topcoat.

Conditioning was carried out in each case with cleaners of different alkalinity according to Table 1 using a spray method at 1 bar for 20 seconds at an application temperature of the composition of 50° C.

TABLE 1

| | CE1 | CE2 | CE3 | E1 |
|---|---|---|---|---|
| pH | 12.7 | 9.0 | 9.1 | 12.6 |
| FA (pH 8.5) | 21.0 | 0 | 0 | 7.5 |
| GA (pH 3.6) | 23.7 | 8.8 | 9.0 | 14.2 |
| GA/FA | 2.1 | — | — | 1.9 |
| Mg/mgkg⁻¹ | 0 | 0 | 120 | 110 |
| Fe/mgkg⁻¹ | 0 | 100 | 100 | 96 |
| P/mgkg⁻¹ | 1600 | — | — | — |
| Gluconate/gkg⁻¹ | 2.5 | 2.5 | 2.5 | 2.5 |
| HEDP/gkg⁻¹ | 0 | 0.2 | 0.2 | 0.2 |
| ATMP/gkg⁻¹ | 0 | 0.2 | 0.2 | 0.2 |

CE1 based on the cleaner Bonderite ® C-AK 703 (Henkel AG & Co. KGaA)
FA free alkalinity
GA total alkalinity
P phosphorus from tripolyphosphates
HEDP etidronic acid (1-Hydroxyethylidene-1,1-diphosphonic acid)
ATMP aminotrimethylenephosphonic acid

Following cleaning and conditioning in the same method step, the sheet metal sections (ZM) were pre-treated to protect against corrosion using the commercial acid passivation agent Bonderite® M-NT 1455 T (Henkel AG & Co. KGaA). The pre-treatment was carried out by roller application and drying of an amount of a wet film of the acid passivation, which resulted in a layer thickness of titanium in the amount of 5 and 1 mg/m², respectively.

After application of the PU primer (PU020PB0070, Akzo Nobel NV) in a dry film thickness of 20 μm and the PU topcoat system (PU747TX80024, Akzo Nobel NV) in a dry film thickness of 30 μm, the blistering was examined in the so-called “Q-Panel Condensation Test” (QCT) according to DIN EN 13523-26:2014-08, in which the correspondingly pre-treated and coated (ZM) sheet metal sections were exposed to water (κ<1 μScm−1) saturated air at 70° C. for 6 weeks.

It was found that with conditioning according to the invention (E1), blistering can be almost completely suppressed even at a layer thickness of 1 mg/m² Ti, whereas strong blistering was observed on all other substrates (CE1-CE3). With a layer thickness of 5 mg/m² Ti, blistering is significantly reduced on the mildly alkaline cleaner containing magnesium (CE3) and when using the strongly alkaline cleaner (CE1), but only in the example according to the invention (E1) is no blistering observed at all. The method according to the invention therefore enables particularly economical operation, in which the material requirement in the corrosion-protecting pre-treatment can be significantly reduced.

1. A method for cleaning and conditioning of galvanized (ZM) steel by contacting galvanized (ZM) steel surfaces with an alkaline aqueous composition containing at least 1.0 mmol/kg of magnesium ions dissolved in an aqueous phase thereof and at least one water-soluble organic complexing agent, wherein the alkaline aqueous composition has a free alkalinity of greater than 3.0 points and a pH value that is greater than 11.5.

2. The method according to claim 1, wherein the alkaline aqueous composition has a total alkalinity of greater than 5.0 points, and a ratio of total alkalinity to free alkalinity of less than 3.0.

3. The method according to claim 2, wherein the pH value of the alkaline aqueous composition is greater than 12.0.

4. The method according to claim 3, wherein the proportion of magnesium ions dissolved in the aqueous phase is at least 2.0 mmol/kg but not more than 0.080 mol/kg, based on the alkaline aqueous composition.

5. The method according to claim 4, wherein the alkaline aqueous composition additionally contains at least 0.4 mmol/kg iron ions but less than 0.040 mol/kg iron ions dissolved in the aqueous phase.

6. The method according to claim 1, wherein the at least one water-soluble organic complexing agent is selected from complexing agents having a complex formation constant pK_{L} for magnesium below 2.0, and are optionally selected from α-hydroxycarboxylic acids.

7. The method according to claim 6, wherein the alkaline aqueous composition additionally contains at least one further complexing agent selected from di- and/or triphosphonic acids.

8. The method according to claim 7, wherein wherein the alkaline aqueous composition contains a yet further complexing agent selected from organic compounds having at least three carboxyl groups and at least one secondary and/or tertiary amino group.

9. The method according to claim 6, wherein the proportion of complexing agents in the alkaline aqueous composition is at least 2.0 mmol/kg, but the total proportion of complexing agents is not greater than 50 mmol/kg, in each case based on the alkaline aqueous composition, wherein the proportion of complexing agents having a complex formation constant pK_{L} for magnesium below 2.0, based on the total proportion of complexing agents is at least 60 mol %, and at least one further complexing agent selected from di-phosphonic acids, triphosphonic acids, organic compounds having at least three carboxyl groups and at least one secondary amino group, organic compounds having at least three carboxyl groups and at least one tertiary amino group and combinations thereof is present.

10. The method according to claim 9, wherein the alkaline aqueous composition additionally contains at least one surfactant wherein a total proportion of surfactant is greater than 0.050 g/kg, but is not greater than 5.0 g/kg, in each case based on the alkaline aqueous composition.

11. The method according to claim 10, wherein the proportion of water-soluble compounds of the elements Ni or Co in the alkaline aqueous composition is in each case less than 10 mg/kg, in each case as a proportion of the element and based on the alkaline aqueous composition.

12. The method according to claim 11, wherein a total proportion of phosphates dissolved in water in the alkaline aqueous composition is less than 0.100 g/kg, calculated as amount of PO₄ and based on the alkaline aqueous composition.

13. The method according to claim 12, wherein the pH value of the alkaline aqueous composition is greater than 12.0, but less than 13.5.

14. The method according to claim 1, wherein the proportion of magnesium ions dissolved in the aqueous phase is at least 3.0 mmol/kg but not more than 0.020 mol/kg, based on the alkaline aqueous composition.

15. The method according to claim 1, wherein the alkaline aqueous composition additionally contains least 1.0 mmol/kg iron ions but less than 0.010 mol/kg iron ions dissolved in the aqueous phase.

16. The method according to claim 1, wherein the at least one water-soluble organic complexing agent is selected from α-hydroxycarboxylic acids having a complex formation constant pK_{L} for magnesium below 1.5.

17. The method according to claim 16, wherein at least one further complexing agent is additionally contained, which is selected from etidronic acid, aminotrimethylene phosphonic acid and combinations thereof; and wherein the α-hydroxycarboxylic acid is selected from glycolic acid, lactic acid, tartaric acid, malic acid, aldaric acids, aldonic acids, gluconic acid and/or glucoheptonic acid.

18. The method according to claim 16 wherein at least one further complexing agent is additionally contained, which is selected from organic compounds having at least three carboxyl groups and at least one secondary and/or tertiary amino group, selected from the group consisting of β-alaninediacetic acid, N-(1-carboxyethyl)iminodiacetic acid, iminodisuccinic acid, diethylenetriaminepentaacetic acid, ethylenediaminetetraacetic acid, nitrilotriacetic acid, and combinations thereof.

19. The method according to claim 9 wherein the proportion of complexing agents in the alkaline aqueous composition is at least 4.0 mmol/kg but the total proportion of complexing agents is not greater than 40 mmol/kg, in each case based on the alkaline aqueous composition, wherein the proportion of complexing agents having a complex formation constant pK_{L} for magnesium below 2.0, based on the total proportion of complexing agents is at least 80 mol %, and comprises aldonic acids and/or glucoheptonic acid.

20. The method according claim 1, wherein the alkaline aqueous composition additionally contains at least one non-ionic surfactant, wherein the total proportion of the non-ionic surfactants, is greater than 0.100 g/kg, but the total proportion of the surfactants is not greater than 2.0 g/kg, in each case based on the alkaline aqueous composition.

21. The method according to claim 1, wherein the proportion of water-soluble compounds of metal elements, which have a more positive standard reduction potential than iron, in the alkaline aqueous composition is in each case less than 5 mg/kg, in each case as a proportion of the element and based on the alkaline aqueous composition and wherein a total proportion of phosphates dissolved in water in the alkaline aqueous composition is less than 0.050 g/kg, calculated as the amount of PO₄ and based on the alkaline aqueous composition.

22. An alkaline aqueous composition having a free alkalinity of greater than 3.0 points and a pH value of greater than 11.0, containing
a) at least 1.0 mmol/kg of magnesium ions dissolved in water, and
b) a system of complexing agents consisting of more than 2.0 mmol/kg, but less than 50.0 mmol/kg, of complexing agents having a complex formation constant pK_{L} for magnesium of less than 2.0, preferably selected from glycolic acid, lactic acid, tartaric acid, malic acid, aldaric acids, aldonic acids and/or glucoheptonic acid, especially preferably from aldonic acids and/or glucoheptonic acid, particularly preferably from gluconic acid, and
c1) more than 1.0 mmol/kg, but less than 10.0 mmol/kg of at least one di- and/or triphosphonic acid, and/or
c2) more than 1.0 mmol/kg, but less than 10.0 mmol/kg of at least one organic compound having at least three carboxyl groups and at least one secondary and/or tertiary amino group.

23. A method for cleaning and corrosion-protecting surface treatment of strip steel having a hot-dip galvanization (ZM) on either one or both sides, comprising steps of:
i) optionally, first degreasing a hot-dip galvanized (ZM) surface of the strip steel product;
ii) treating the hot-dip galvanized (ZM) surface according to the method of claim 1;
iii) subsequently conversion coating the treated hot-dip galvanized (ZM) surface of step ii) by contacting with an acidic aqueous composition containing water-soluble compounds of the elements Zr, Ti and/or Si, the acidic aqueous composition having a pH value in a range from 1.0 to 5.0, and optionally contains an amount of free fluoride, and wherein the contacting is carried out by applying a wet film of the acidic aqueous composition, optionally by spraying/squeezing or rolling on;
iv) drying the wet film in place forming a conversion coating; and
v) providing the conversion with either
a. a topcoat, with or without a previous primer coating, or
b. a dip paint, optionally an electrophoretic dip paint.

24. The method according to claim 23, wherein the contacting with the acidic aqueous composition containing water-soluble compounds of the elements Zr, Ti and/or Si, is carried out for such a duration or in such an application quantity that on the hot-dip galvanized (ZM) surfaces of the strip steel, after the drying step, results a layer thickness of Zr, Ti and/or Si of at least 1 mg/m² in each case, based on the respective element, but not more than 20 mg/m² in total based on the elements Zr, Ti and/or Si.
